(19) United States
(12) Patent Application Publication
(10) Pub. No.: US 2026/0187423 A1
(43) Pub. Date: Jul. 2, 2026

(54) EVALUATION METHOD FOR HEALTH STATUS OF INDUSTRIAL COMPLEX SYSTEM BASED ON PHYSICAL INFORMATION NEURAL NETWORK MODEL

(71) Applicant: XI'AN JIAOTONG UNIVERSITY, Xi'an (CN)

(72) Inventors: Zhibin ZHAO, Xi'an (CN); Fujin WANG, Xi'an (CN); Yi DI, Xi'an (CN); Hongming YUAN, Xi'an (CN); Zhi ZHAI, Xi'an (CN); Xuefeng CHEN, Xi'an (CN)

(21) Appl. No.: 19/250,813

(22) Filed: Jun. 26, 2025

(30) Foreign Application Priority Data
Dec. 27, 2024 (CN) 2024119592315

(51) Int. Cl. G06N 3/049; G06N 3/08

(52) U.S. Cl. CPC G06N 3/049; G06N 3/08

(57) ABSTRACT

Disclosed in the present disclosure is an evaluation method for a health status of an industrial complex system based on a physical information neural network model, including: acquiring status monitoring data of an industrial complex system; building an empirical degradation model of the industrial complex system, and constructing a physical information neural network model based on the empirical degradation model, the physical information neural network model including a solution network and a dynamic network; constructing statistical features from the status monitoring data as an input, and training the physical information neural network model; and after training of the physical information neural network model is completed, performing forward reasoning by using the solution network to predict the health status of the industrial complex system. The method of the present disclosure incorporates the physical model into the neural network model to improve the accuracy and stability of health status evaluation.

### CROSS-REFERENCE TO RELATED APPLICATION

This application claims priority from the Chinese patent application 2024119592315 filed Dec. 27, 2024, the content of which is incorporated herein in the entirety by reference.

### TECHNICAL FIELD

The present disclosure belongs to the field of prognosis and health management of industrial complex systems, and particularly relates to an evaluation method for a health status of an industrial complex system based on a physical information neural network model.

### BACKGROUND

In modern industrial production, stable operation of key equipment is critical for ensuring the production efficiency and product quality. With the improvement of industrial automation and intelligence, higher requirements are put forward for the monitoring and management of the health status of complex industrial systems. Traditional industrial complex system maintenance typically employs regular inspection or post-failure repairs, which often fails to achieve early detection and prevention of faults, potentially resulting in production interruptions and economic losses.

In recent years, with the rapid development of the artificial intelligence technology, especially the successful application of deep learning in the fields of image recognition, natural language processing and the like, people have begun to explore its application in fault diagnosis and health evaluation of industrial complex systems. As a powerful machine learning tool, a neural network can learn complex patterns and relationships from large amounts of data. However, most of the existing neural network models rely on statistical data learning, lack the ability to deeply understand physical processes, and have large fluctuations in predicting the health status of the industrial complex systems, which limits their application in health management of the industrial complex systems to some extent.

### SUMMARY

In view of the shortcomings in the prior art, an object of the present disclosure is to provide an evaluation method for a health status of an industrial complex system based on a physical information neural network model. The method combines the advantages of a physical model and a neural network by building an empirical degradation model of the industrial complex system and incorporating the model into a physical information neural network. To make the prediction results more stable and accurate, a loss function with a physical meaning is designed to optimize the physical information neural network model.

To achieve the above object, the present disclosure provides the following technical solutions:
an evaluation method for a health status of an industrial complex system based on a physical information neural network model includes the steps of:
S100: acquiring status monitoring data of an industrial complex system;
S200: building an empirical degradation model of the industrial complex system, and constructing a physical information neural network model based on the empirical degradation model, the physical information neural network model including a solution network and a dynamic network;
S300: constructing statistical features from the status monitoring data as an input, and training the physical information neural network model; and
S400: after training of the physical information neural network model is completed, performing forward reasoning by using the solution network to predict the health status of the industrial complex system.

Preferably, Step S200 includes:
S201: constructing a partial differential equation satisfying a degradation trajectory of the industrial complex system based on the empirical degradation model of the industrial complex system; and
S202: constructing a physical information neural network based on the partial differential equation, the network including a solution network and a dynamic network.

Preferably, in Step S201, the built empirical degradation model of the industrial complex system can be expressed as:

$$u = f ( t , x ) ,$$

wherein u denotes the degradation trajectory of the industrial complex system, and is described by a non-linear function ƒ(·), t denotes the time, and x denotes a feature vector.

Preferably, an aging rate of the industrial complex system is expressed in the form of a partial differential equation:

$$\frac{\partial f ( t , x )}{\partial t} = g ( t , x , u ; θ ) ,$$

wherein θ denotes a parameter of the partial differential equation, g(·) denotes a non-linear function of the time t, the feature vector x and the degradation trajectory u itself, and g(·) is used to capture and characterize the internal dynamics of degradation of the industrial complex system.

Preferably, in Step S202, the degeneration trajectory ƒ(·) is fitted by using a neural network [symbol] (·), and the network is referred to as the solution network; and the internal dynamic function g(·) of degradation of the industrial complex system is captured by using a neural network [symbol] (·), and the network is referred to as the dynamic network.

Preferably, the physical information neural network model is expressed as:

$$ℋ := \frac{\partial ℱ ( t , x ; Φ )}{\partial t} - 𝒢 ( t , x , u , {u}_{t} , {u}_{x} ; Θ ) ,$$

wherein Φ and θ respectively denote learnable parameters of the neural network,

$${u}_{t} = \frac{\partial u}{\partial t}$$

denotes a partial derivative of u with respect to the time t, and

$${u}_{x} = {[ \frac{\partial u}{\partial {x}_{1}} , \frac{\partial u}{\partial {x}_{2}} , ⋯ ]}^{⊤}$$

denotes a partial derivative of u with respect to the feature vector x, wherein both partial derivatives are computed by using an automatic differentiation mechanism of deep learning.

Preferably, Step S300 includes the steps of:
S301: segmenting acquired status monitoring signals, and constructing the statistical features, such as a mean value, a standard deviation, a minimum value, a maximum value, a kurtosis, and skewness, and marking a corresponding health status label u;
S302: inputting the time t and the feature vector x composed of the statistical features into the solution network to obtain an estimated value of the health status, denoted as:

$$u = ℱ ( t , x ; Φ ) ,$$

wherein û denotes the estimated health status and [symbol] (·) denotes the solution network;
S303: calculating a root mean square error between the estimated value û and a true value u as a loss function:

$${ℒ}_{MSE} = {\sum }_{i = 1}^{N} {\vert {u}^{i} - {\hat{u}}^{i} \vert}^{2} ,$$

wherein a superscript i denotes an i th sample and N denotes the number of samples;
S304: jointly inputting the time t, the feature @, the estimated value û and related partial derivatives thereof ût and ûₓ into the dynamic network to obtain an estimated aging rate [symbol] (t,x,û,ûₜ,ûₓ;θ). Based on the constructed physical information neural network model, the partial differential equation loss can be calculated:

$${ℒ}_{PDE} = {\sum }_{i = 1}^{N} {\vert ℋ ( {t}^{i} , {x}^{i} ) \vert}^{2}$$

$$ℋ ( {t}^{i} , {x}^{i} ) = \frac{\partial ℱ ( {t}^{i} , {x}^{i} ; Φ )}{\partial t} - 𝒢 ( {t}^{i} , {x}^{i} , {\hat{u}}^{i} , {\hat{u}}_{t}^{i} , {\hat{u}}_{x}^{i} ; Θ ) ,$$

wherein [symbol] _{PDE} is a PDE loss function;
S305: designing a monotonicity loss function according to the monotonicity of the aging process of the industrial complex system:

$${ℒ}_{mono} = {\sum }_{i = 1}^{N} ReLU ( {\hat{u}}^{i + 1} - {\hat{u}}^{i} ) ,$$

wherein ReLU(·) denotes a rectified linear unit;
S306: constructing an overall optimization objective function of the physical information neural network model by combining the root mean square error loss function [symbol] _{MSE}, the PDE loss function [symbol] _{PDE} and the monotonicity loss function [symbol] ₘₒₙₒ, calculating a loss value, and performing backpropagation; and
S307: repeatedly performing Step S302 to step S306, and when the number of iterations reaches a set maximum number of iterations, completing training of the physical information neural network model.

Preferably, in Step S306, the overall optimization objective function [symbol] is expressed as:

$$ℒ = {ℒ}_{MSE} + {αℒ}_{PDE} + {βℒ}_{mono} ,$$

wherein α and β denote trade-off coefficients. The trade-off coefficients may be searched by using a grid search technique to ultimately determine an optimal coefficient combination.

Preferably, in Step 400, after training of the physical information neural network model is completed, the solution network can be used to estimate the health state of the industrial complex system to be estimated, and the dynamic network can be discarded.

The present disclosure further discloses an evaluation system for a health status of an industrial complex system based on a physical information neural network model, including:
an acquisition module, configured to acquire status monitoring data of an industrial complex system;
a construction module, configured to construct an empirical degradation model of the industrial complex system according to the status monitoring data, and construct a physical information neural network model based on the empirical degradation model;
a training module, configured to construct statistical features from the status monitoring data as an input, and train the physical information neural network model; and
a prediction module, configured to perform forward reasoning to predict the health status of the industrial complex system after training of the physical information neural network model is completed.

The present disclosure further discloses a computer storage medium, wherein the storage medium includes computer instructions which, when run on a computer, cause the computer to perform any one of the methods described above.

The present disclosure further discloses an electronic device, including a memory, a processor and a computer program stored on the memory and executable on the processor, wherein the processor, when executing the program, implements any one of the methods described above.

Compared with the prior art, the beneficial effects brought about by the present disclosure are as follows:

1. Compared with the traditional method and a data-driven method, the method of the present disclosure combines the advantages of the physical model and the data-driven method, builds the empirical degradation model of the industrial complex system, introduces physical knowledge into the neural network, and realizes the physical information neural network model, so that the prediction results are more accurate and stable, and conform to the physical law.

2. Considering the monotonicity of the degradation process of the industrial complex system, a loss satisfying the physics law is designed to optimize the physical information neural network model, making the number of samples required for the model less and the prediction results more accurate.

### BRIEF DESCRIPTION OF DRAWINGS

FIG. 1 is a schematic flowchart of an evaluation method for a health status of an industrial complex system based on a physical information neural network model according to one embodiment of the present disclosure;

FIG. 2 is a schematic diagram of application of an evaluation system for a health status of an industrial complex system based on a physical information neural network model according to another embodiment of the present disclosure;

FIG. 3 is a schematic diagram of a physical information neural network model according to another embodiment of the present disclosure;

FIG. 4 is a schematic diagram of visualization of data used by the physical information neural network model according to another embodiment of the present disclosure;

FIG. 5 is a schematic diagram of extracting features by the physical information neural network model according to another embodiment of the present disclosure; and

FIG. 6 is a schematic diagram showing the results predicted by the physical information neural network model according to another embodiment of the present disclosure.

### DETAILED DESCRIPTION OF THE INVENTION

Specific embodiments of the present disclosure will be described in detail below with reference to the accompanying drawings. Although specific embodiments of the present disclosure are illustrated in the accompanying drawings, it should be understood that the present disclosure may be embodied in various forms and should not be limited by the embodiments set forth herein. Rather, these embodiments are provided in order to enable a more thorough understanding of the present disclosure and fully convey the scope of the present disclosure to those skilled in the art.

It should be noted that certain terms are used throughout the description and claims to refer to certain components. It will be appreciated by those skilled in the art that different terms may be used by those skilled to refer to the same component. The description and claims do not use differences in terms as a means of distinguishing components, but use differences in functions of components as a criterion for distinguishing. “Comprising” or “including” mentioned throughout the description and claims is an open-ended term, and thus, should be interpreted as “including, but not limited to.” The following description in the specification is to describe preferred embodiments for carrying out the present disclosure, but the description is for the purpose of general principles of the specification and is not intended to limit the scope of the present disclosure. The protection scope of the present disclosure is defined by the appended claims.

In order to facilitate an understanding of the embodiments of the present disclosure, further explanation will be made below by taking specific embodiments as examples with reference to the accompanying drawings, and the accompanying drawings are not to be construed as limiting the embodiments of the present disclosure.

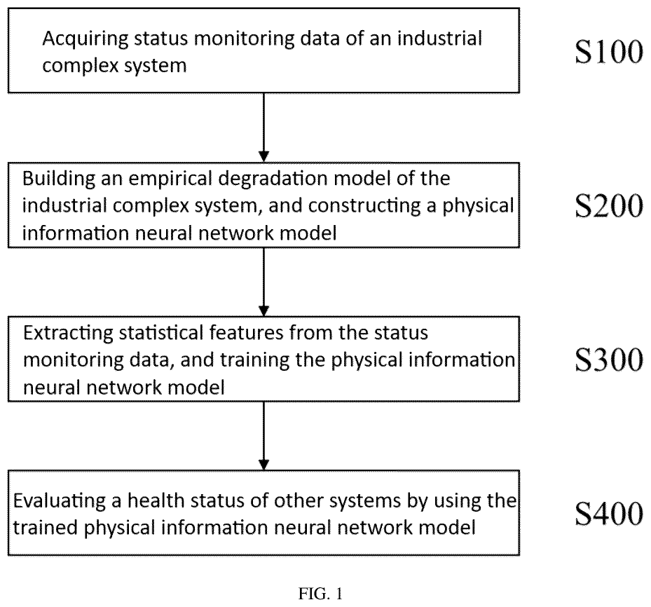

In one embodiment, as shown in FIG. 1, the present disclosure provides an evaluation method for a health status of an industrial complex system based on a physical information neural network model, including the steps of:
S100: acquiring status monitoring data of an industrial complex system;
S200: building an empirical degradation model of the industrial complex system, and constructing a physical information neural network model based on the empirical degradation model, the physical information neural network model including a solution network and a dynamic network;
S300: constructing statistical features from the status monitoring data as an input, and training the physical information neural network model; and
S400: after training of the physical information neural network model is completed, performing forward reasoning by using the solution network to predict the health status of the industrial complex system.

The above embodiment constitutes a complete technical method of the present disclosure. The method of the present disclosure combines the advantages of a physical model and a data-driven method, builds the empirical degradation model of the industrial complex system, and introduces physical knowledge into a neural network, so that the prediction results are more accurate and stable, and conforms to the physical law.

In another embodiment, in Step S100, the status monitoring data of the industrial complex system is acquired. In particular, monitoring data that can be achieved for different industrial complex systems varies. For example, for a rotating mechanical device, signals such as a displacement, a velocity, an acceleration, and a temperature can be acquired; and for a power supply system, signals such as a voltage, a current, a temperature, and an electric quantity can be acquired. In the present disclosure, by taking a commercial modular aero-propulsion system simulation (C-MAPSS) data set published by the national aeronautics and space administration (NASA) as an example, achieved data includes a cycle number and 14 sensor values such as a total temperature at a low-pressure compressor outlet (S2), a total temperature at a high-pressure compressor outlet (S3), a total temperature at a low-pressure turbine outlet (S4), a total pressure at the high-pressure compressor outlet (S7), an actual rotational speed of a fan (S8), an actual rotational speed of a core engine (S9), a static pressure at the high-pressure compressor outlet (S11), a fuel flow rate ratio (S12), a corrected rotational speed of the fan (S13), a corrected rotational speed of the core engine (S14), a bypass ratio (S15), a bleed air enthalpy value (S17), a bleed air cooling flow rate of a high-pressure turbine (S20), and a bleed air cooling flow rate of a low-pressure turbine (S21). The changes in the 14 sensor values are shown in FIG. 4.

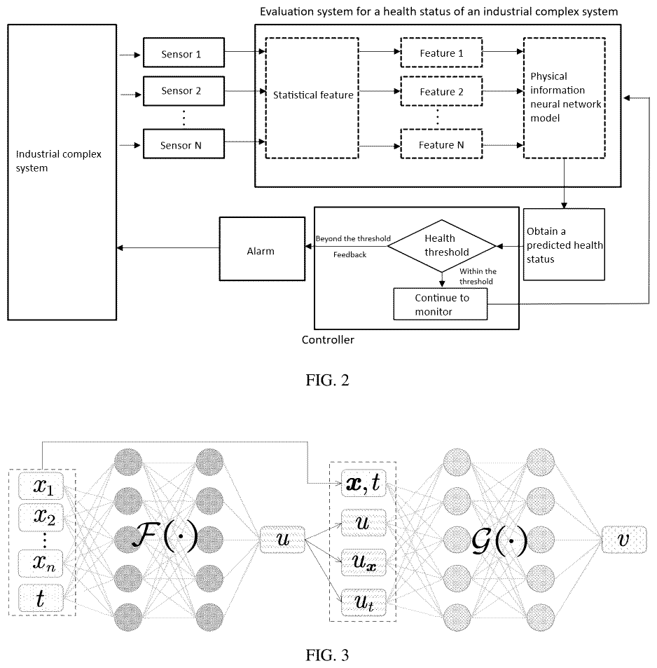

In another embodiment, referring to FIG. 2, the present disclosure discloses an evaluation system for a health status of an industrial complex system based on a physical information neural network model. The system achieves status monitoring data of the industrial complex system via a plurality of sensors (e.g., a sensor 1, a sensor 2, . . . , a sensor N, where the sensors may be a voltage sensor, a current sensor, a temperature sensor, a vibration sensor, or the like), and then the evaluation system for a health status of an industrial complex system outputs a predicted health status into a controller for further judgment, where
when compared with a health threshold, the controller determines that the predicted health status is within the threshold, the industrial complex system can be considered healthy, and the controller continues to monitor the industrial complex system through the evaluation system for a health status of an industrial complex system;
when compared with the health threshold, the controller determines that the predicted health status is beyond the threshold, the industrial complex system can be considered unhealthy, the controller feeds back such situation to an alarm, and the alarm gives an alarm of the industrial complex system, so as to guide workers in overhauling, etc.;
wherein the evaluation system for a health status of an industrial complex system may be implemented as a processor and a memory, the memory mainly stores a physical information neural network model, the processor then computes statistical features based on signals of the plurality of sensors to obtain a feature 1, a feature 2, . . . , and a feature N, and then the physical information neural network model further outputs the predicted health status.

It should be noted that in another embodiment, the present disclosure can also implement the evaluation system for a health status of an industrial complex system based on a physical information neural network model in another manner, including:
an acquisition module, configured to acquire status monitoring data of an industrial complex system;
a construction module, configured to construct an empirical degradation model of the industrial complex system according to the status monitoring data, and construct a physical information neural network model based on the empirical degradation model;
a training module, configured to construct statistical features from the status monitoring data as an input, and train the physical information neural network model; and
a prediction module, configured to perform forward reasoning to predict the health status of the industrial complex system after training of the physical information neural network model is completed.

It can be found that in the evaluation system for a health status of an industrial complex system disclosed in this embodiment, the acquisition module may include a plurality of sensors.

In another embodiment, Step S200 includes:
S201: constructing a partial differential equation satisfying a degradation trajectory of the industrial complex system based on the empirical degradation model of the industrial complex system; and
S202: constructing a physical information neural network based on the partial differential equation, the network including a solution network and a dynamic network.

In Step S201, the built empirical degradation model of the industrial complex system can be expressed as:

$$u = f ( t , x ) ,$$

wherein u denotes the degradation trajectory of the industrial complex system, and is described by a non-linear function ƒ(·), t denotes the time, and x denotes a feature vector.

It can be understood that aging of the industrial complex system is not only related to the time, but also is related to other factors, so an aging process of the industrial complex system is modeled as a multivariate function of the time t and other feature vectors x.

Without loss of generality, an aging rate of the industrial complex system can be expressed in the form of a partial differential equation:

$$\frac{\partial f ( t , x )}{\partial t} = g ( t , x , u ; θ )$$

wherein θ denotes a parameter of the partial differential equation, and g(·) denotes a non-linear function of the time t, the feature vector x and the degradation trajectory u itself. g(·) is used to capture and characterize the internal dynamics of degradation of the industrial complex system.

In Step S202, the physical information neural network is constructed based on the partial differential equation, the network including the solution network and the dynamic network.

It should be noted that a display form of the non-linear function g(·) is unknown and difficult to obtain, so the non-linear function g(·) can be represented by a more generalized function approximator g′(·) parameterized by θ′, expressed as:

$$\frac{\partial f ( t , x )}{\partial t} = {g}^{′} ( t , x , u , {u}_{t} , {u}_{x} , {u}_{xx} , ⋯ ; {θ}^{′} )$$

wherein uₜ denotes a first-order partial derivative of u with respect to t, u_{z} denotes a first-order partial derivative of u with respect to x, and uₓₓ denotes a second-order partial derivative of u with respect to x. The function approximator g′(·) provides a relationship between

$$\frac{\partial f ( t , x )}{\partial t}$$

and t, x, u and their partial derivatives of any order.

It should also be noted that during the optimization process, a neural network needs to compute a gradient (i.e., a partial derivative) of an output to each input and perform gradient backpropagation to update model parameters. This process can be automatically computed by deep learning frameworks such as Pytorch. These partial derivatives include the partial derivative relationship required in the modeling process of the industrial complex system, so no additional partial derivative calculation process is required, that is, the above partial derivative relationship can be obtained by an automatic differentiation mechanism of deep learning.

The partial derivative relationship can be computed by using the automatic differentiation mechanism of deep learning, and the degradation trajectory ƒ(·) is modeled with a neural network [symbol] (·) which is called a solution network; and exemplarily, the solution network consists of a residual module, a linear layer, a ReLU layer, and a linear layer in sequence. The residual module contains 5 one-dimensional convolution layers, each convolution layer using 3×1 convolution kernels with a stride of 1 and a padding of 1, where the one-dimensional convolution kernels have a size of 3.

In addition, in the present disclosure, a neural network [symbol] (·) which is called a dynamic network is used to model the function approximator g′(·); and exemplarily, the dynamic network consists of 3 linear layers with two middle linear layers as hidden layers, each hidden layer having a width of 32; and in the dynamic network, there is a ReLU layer as an activation layer between any two layers, and droupout is set to be 0.2.

Exemplarily, the physical information neural network model of the present disclosure can be expressed as:

$$ℋ = \frac{\partial ℱ ( t , x ; Φ )}{\partial t} - 𝒢 ( t , x , u , {u}_{t} , {u}_{x} ; Θ )$$

wherein Φ and θ respectively denote learnable parameters of the neural network,

$${u}_{t} = \frac{\partial u}{\partial t}$$

denotes a partial derivative of u with respect to the time t, and

$${u}_{x} = {[ \frac{\partial u}{\partial {x}_{1}} , \frac{\partial u}{\partial {x}_{2}} , ⋯ ]}^{⊤}$$

denotes a partial derivative of u with respect to the feature vector x.

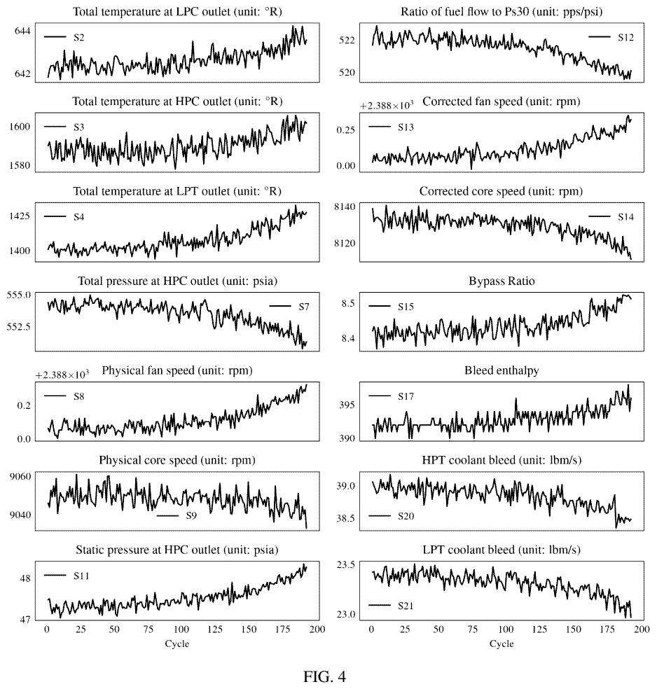

The physical information neural network model built according to this embodiment is shown in FIG. 3. The physical information neural network model consists of a solution network [symbol] (·) and a dynamic network [symbol] (·). An input of [symbol] (·) includes the feature vector x composed of statistical features and the time t, wherein x has a dimension of 84, representing 14 sensor channels, 6 features are extracted per sensor value, and these features include a mean value, a standard deviation, a minimum value, a maximum value, a kurtosis, and a skewness; the time t has a dimension of 1; and an output of [symbol] (·) is a predicted tag value. An input of [symbol] (·) is a vector formed by splicing the feature vector x composed of statistical features, the time t, the input u of [symbol] (·) and its partial derivatives uₜ and uₓ, with a dimension of 84, 1, 1, 1, and 84, respectively; and an output of [symbol] (·) is a degradation rate of the complex system. As can be seen from the drawing, the dynamic network [symbol] (·) only plays an auxiliary role in the training process, and once the training is complete, [symbol] (·) will be discarded and [symbol] (·) is used only to predict the health status of the system. It can be understood that the solution network [symbol] (·) and the dynamic network [symbol] (·) in FIG. 3 are merely descriptions of the functions of the network modules, which may be composed of a convolutional neural network, a fully connected neural network, or a recurrent neural network, etc., rather than a specific structure. Different terms may be used by those skilled to refer to the same component. The description and claims do not use differences in terms as a means of distinguishing components, but use differences in functions of components as a criterion for distinguishing.

In another embodiment, Step S300 includes the following steps:
S301: The acquired monitoring signals are discrete signals according to the description of the C-MAPSS data set. The acquired status monitoring signals are segmented with a window length of 30, and statistical features including a mean value, a standard deviation, a minimum value, a maximum value, a kurtosis, and a skewness, are constructed from signals acquired by the 14 sensors, these features are combined into a feature vector x, and a corresponding health state label u is marked;
it should to be noted that not only can these statistical features be calculated, but also other statistical features can be calculated. Here, these features are only taken as an example for illustration.

S302: the time t and the feature vector x composed of statistical features are input into the solution network to obtain an estimated value of the health status, denoted as:

$$\hat{u} = f ( t , x ; Φ )$$

wherein û denotes the estimated value of the health status, [symbol] (·) denotes the solution network, and Φ denotes a learnable parameter of the neural network.

S303: a root mean square error between the estimated value û and a true value u is calculated as a loss function:

$${ℒ}_{MSE} = {\sum }_{i = 1}^{N} {\vert {u}^{i} - {\hat{u}}^{i} \vert}^{2} ,$$

wherein a superscript i denotes an i th sample and N denotes the number of samples.

S304: the time t, the feature vector x, the estimated value û and related partial derivatives thereof ûₜ and ûₓ are jointly input into the dynamic network to obtain an estimated aging rate [symbol] (t, x, û, ûₜ, ûₓ; θ).

According to the physical information neural network model built in the previous embodiment, the partial differential equation loss can be calculated:

$${ℒ}_{P D E} = {\sum }_{i = 1}^{N} {\vert ℋ ( {t}^{i} , {x}^{i} ) \vert}^{2} \\ ℋ ( {t}^{i} , {x}^{i} ) = \frac{\partial ℱ ( {t}^{i} , {x}^{i} ; Φ )}{\partial t} - 𝒢 ( {t}^{i} , {x}^{i} , {\hat{u}}^{i} , {\hat{u}}_{t}^{i} , {\hat{u}}_{x}^{i} ; Θ )$$

It can be understood that according to the constructed physical information neural network model, after training is completed, the aging rate calculated according to the prediction results of the solution network model should be equal to the aging rate estimated by the dynamic network, and therefore, the physical information neural network model should be optimized towards [symbol] (tⁱ,xⁱ)=0.

S305: a monotonicity loss function is designed according to the monotonicity of the aging process of the industrial complex system:

$${ℒ}_{m o n o} = {\sum }_{i = 1}^{N - 1} ReLU ( {\hat{u}}^{i + 1} - {\hat{u}}^{i} )$$

wherein ReLU (·) denotes a rectified linear unit.

It can be understood that the aging trajectory of the industrially complex system is monotonic, i.e., the health status value of the sample at an i+1 th moment is smaller than the health status value of the sample at an i th moment. When the predicted value of the model satisfies ûⁱ⁺¹−ûⁱ>0, a penalty needs to be imposed on the model, i.e., [symbol] ₘₒₙₒ≠0; and when the predicted value of the model satisfies the physical law ûⁱ⁺¹−ûⁱ<0, [symbol] ₘₒₙₒ=0.

S306: an overall optimization objective function of the physical information neural network model is constructed by combining the root mean square error loss function [symbol] _{MSE}, the PDE loss function [symbol] _{PDE} and the monotonicity loss function [symbol] ₘₒₙₒ, a loss value is calculated, and backpropagation is performed.

The overall optimization objective function [symbol] is expressed as:

$$ℒ = {ℒ}_{MSE} + {αℒ}_{PDE} + {βℒ}_{m o n o}$$

wherein α and β denote trade-off coefficients. The trade-off coefficients may be searched by using a grid search technique to ultimately determine an optimal coefficient combination, preferably where α=10, and β=0.1.

S307: Step S302 to step S306 are repeatedly performed, and when the number of iterations reaches a set maximum number of iterations, training of the physical information neural network model is completed.

In another embodiment, in Step S400, after training of the physical information neural network model is completed, the solution network may be used to estimate the health status of the industrial complex system to be estimated, and the dynamic network may be discarded.

The present disclosure is further described below in connection with FIGS. 3 to 5:

FIG. 3 shows the constructed physical information neural network model consisting of a solution network [symbol] (·) and a dynamic network [symbol] (·). An input of [symbol] (·) includes the constructed feature vector x and the time t, and an output of [symbol] (·) is the predicted health status or the remaining useful life; an input of [symbol] (·) is a vector formed by splicing statistical features, the time, the output of [symbol] (·) and its partial derivatives, and an output of [symbol] (·) is a degradation rate of the complex system. As can be seen from the drawing, the dynamic network [symbol] (·) only plays an auxiliary role in the training process, and once the training is complete, [symbol] (·) will be discarded and [symbol] (·) is used only to predict the health status of the system. It can be understood that the solution network [symbol] (·) and the dynamic network [symbol] (·) in FIG. 3 are merely descriptions of the functions of the network modules, which may be composed of a convolutional neural network, a fully connected neural network, or a recurrent neural network, etc., rather than a specific structure. Different terms may be used by those skilled to refer to the same component. The description and claims do not use differences in terms as a means of distinguishing components, but use differences in functions of components as a criterion for distinguishing.

FIG. 4 is a schematic diagram of different channel data of the C-MAPSS data set. S2 denotes a measured value of the sensor 2, which is similar in other sub-figures. By deleting sensors of which a median of a whole life cycle is unchanged, a total of measured values of 14 sensors are selected as source data in the embodiment, and the 14 channels respectively represent: a total temperature at a low-pressure compressor outlet (S2), a total temperature at a high-pressure compressor outlet (S3), a total temperature at a low-pressure turbine outlet (S4), a total pressure at the high-pressure compressor outlet (S7), an actual rotational speed of a fan (S8), an actual rotational speed of a core engine (S9), a static pressure at the high-pressure compressor outlet (S11), a fuel flow rate ratio (S12), a corrected rotational speed of the fan (S13), a corrected rotational speed of the core engine (S14), a bypass ratio (S15), a bleed air enthalpy value (S17), a bleed air cooling flow rate of a high-pressure turbine (S20), and a bleed air cooling flow rate of a low-pressure turbine (S21).

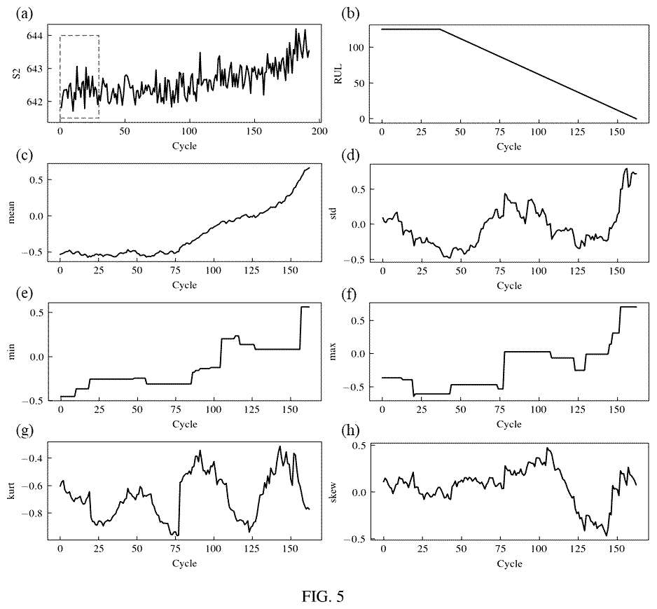

In FIG. 5, (a) is a schematic diagram of data from the sensor 2, and because of its large fluctuation, a window with a window length of 30 is selected to perform sliding window processing on the data, and a mean value (see (c) in FIG. 5), a standard deviation (see (d) in FIG. 5), a minimum value (see (e) in FIG. 5), a maximum value (see (f) in FIG. 5), a kurtosis (see (g) in FIG. 5), and a skewness (see (h) in FIG. 5) within the window are calculated. It should be noted that (b) in FIG. 5 is a curve showing the remaining useful life.

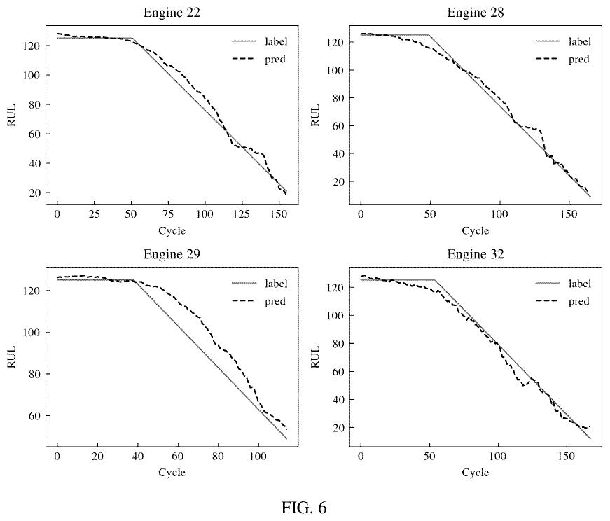

FIG. 6 is a schematic diagram of predicted results according to the present disclosure. It can be seen that in the present disclosure, a curve showing the remaining life of the industrial complex system can be better predicted via the physical information neural network model.

The technical solution of the present disclosure is further illustrated below with the C-MAPSS data set as test data. C-MAPSS is a commercial modular aero-propulsion system simulation data set published by the NASA for the prediction of the remaining life of an aero-engine. The data set contains a total of 26 columns, a first column being a unit number of a turbofan engine, a second column being the number of cycles of operation of an engine in a certain unit, columns 3 to 5 being three input parameters, and the remaining 21 columns being sensor monitoring data. The C-MAPSS data set contains 4 sub-data sets, and the present disclosure selects a first sub-data set, where a training set and a test set contain data of 100 engines, respectively. By deleting data from sensors of which a median of a whole life cycle is unchanged, as well as the input parameters, a total of measured values of 14 sensors are selected as source data for testing in the present disclosure, as shown in FIG. 4.

Each sensor data is subjected to sliding window processing by using a window with a length of 30, and statistical features within the window are calculated, as shown in FIG. 5. These features and the number of cycles are used as inputs of the physical information neural network model to predict the remaining useful life of the engine, with the root mean square error (RMSE) as an evaluation index. The model training parameters are set as follows: a batch size is 256, epoch is set to be 150, and a learning rate is set to 2e-3. In order to demonstrate the effectiveness of the proposed method, a convolutional neural network (CNN), a long short-term memory network (LSTM), a random forest (RF) and a support vector machine (SVM) are compared, and the prediction results of different methods are shown in Table 1.

TABLE 1

| Method | PINN (Ours) | CNN | LSTM | RF | SVM |
|---|---|---|---|---|---|
| RMSE | 15.65 | 18.45 | 16.14 | 17.91 | 40.72 |

As can be seen from the results in the table, the physical information neural network model designed in the present disclosure has a smaller estimation error.

In another embodiment, the present disclosure further discloses a computer storage medium, wherein the storage medium includes computer instructions which, when run on a computer, cause the computer to perform any one of the methods described above.

In another embodiment, the present disclosure further discloses an electronic device, wherein the electronic device includes a memory, a processor, and a computer program stored on the memory and executable on the processor, wherein the processor, when executing the program, implements any one of the methods described above.

The specific embodiments described above are merely illustrative, instructional, and not restrictive. Those of ordinary skill in the art can make many forms under the inspiration of this specification and without departing from the scope of the claims of the present disclosure, which are all within the scope of the protection of the present disclosure.

1. An evaluation method for a health status of an industrial complex system based on a physical information neural network model, comprising the steps of:
S100: acquiring status monitoring data of an industrial complex system;
S200: building an empirical degradation model of the industrial complex system, and constructing a physical information neural network model based on the empirical degradation model, the physical information neural network model comprising a solution network and a dynamic network;
S300: constructing statistical features from the status monitoring data as an input, and training the physical information neural network model; and
S400: after training of the physical information neural network model is completed, performing forward reasoning by using the solution network to predict the health status of the industrial complex system.

2. The method according to claim 1, wherein Step S200 comprises:
S201: constructing a partial differential equation satisfying a degradation trajectory of the industrial complex system based on the empirical degradation model of the industrial complex system; and
S202: constructing the physical information neural network model based on the partial differential equation.

3. The method according to claim 2, wherein in Step S201, the empirical degradation model of the industrial complex system is expressed as:
$$u = f ( t , x ) ,$$
wherein u denotes the degradation trajectory of the industrial complex system, and is described by a non-linear function ƒ(·), t denotes the time, and x denotes a feature vector.

4. The method according to claim 3, wherein an aging rate of the industrial complex system is expressed in the form of a partial differential equation:
$$\frac{\partial f ( t , x )}{\partial t} = g ( t , x , u ; θ ) ,$$
wherein θ denotes a parameter of the partial differential equation, g(·) denotes a non-linear function of the time t, the feature vector x and the degradation trajectory u itself, and g(·) is an internal dynamic function of degradation of the industrial complex system.

5. The method according to claim 3, wherein the degeneration trajectory ƒ(·) being the solution network [symbol] (·), is fitted by using a neural network [symbol] (·), the neural network.

6. The method according to claim 4, wherein the internal dynamic function g(·) of degradation of the industrial complex system is captured by using a neural network [symbol] (·), the neural network [symbol] (·) being the dynamic network.

7. The method according to claim 6, wherein the physical information neural network model is as follows:
$$ℋ := \frac{\partial ℱ ( t , x ; Φ )}{\partial t} - 𝒢 ( t , x , u , {u}_{t} , {u}_{x} ; Θ )$$
where Φ and θ respectively denote learnable parameters of the neural network,
$${u}_{t} = \frac{\partial u}{\partial t}$$
denotes a partial derivative of u with respect to the time x, and
$${u}_{x} = {[ \frac{\partial u}{\partial {x}_{1}} , \frac{\partial u}{\partial {x}_{2}} , … ]}^{⊤}$$
denotes a partial derivative of u with respect to the feature vector x, wherein both partial derivatives are computed by using an automatic differentiation mechanism of deep learning.

8. An evaluation system for a health status of an industrial complex system based on a physical information neural network model, comprising:
an acquisition module, configured to acquire status monitoring data of an industrial complex system;
a construction module, configured to construct an empirical degradation model of the industrial complex system according to the status monitoring data, and construct a physical information neural network model based on the empirical degradation model;
a training module, configured to construct statistical features from the status monitoring data as an input, and train the physical information neural network model; and
a prediction module, configured to perform forward reasoning to predict the health status of the industrial complex system after training of the physical information neural network model is completed.

9. A computer storage medium, wherein the storage medium comprises computer instructions which, when run on a computer, cause the computer to perform the method according to claim 1.

10. An electronic device, comprising a memory, a processor and a computer program stored on the memory and executable on the processor, wherein the processor, when executing the program, implements the method according to claim 1.

11. The computer storage medium of claim 9, wherein Step S200 comprises:
S201: constructing a partial differential equation satisfying a degradation trajectory of the industrial complex system based on the empirical degradation model of the industrial complex system; and
S202: constructing the physical information neural network model based on the partial differential equation.

12. The computer storage medium of claim 11, wherein in Step S201, the empirical degradation model of the industrial complex system is expressed as:
$$u = f ( t , x ) ,$$
wherein u denotes the degradation trajectory of the industrial complex system, and is described by a non-linear function ƒ(·), t denotes the time, and x denotes a feature vector.

13. The computer storage medium of claim 12, wherein an aging rate of the industrial complex system is expressed in the form of a partial differential equation:
$$\frac{\partial f ( t , x )}{\partial t} = g ( t , x , u ; θ ) ,$$
wherein θ denotes a parameter of the partial differential equation, g(·) denotes a non-linear function of the time t, the feature vector x and the degradation trajectory u itself, and g(·) is an internal dynamic function of degradation of the industrial complex system.

14. The computer storage medium of claim 12, wherein the degeneration trajectory ƒ(·) is fitted by using a neural network [symbol] (·), the neural network [symbol] (·) being the solution network.

15. The computer storage medium of claim 13, wherein the internal dynamic function g(·) of degradation of the industrial complex system is captured by using a neural network [symbol] (·), the neural network [symbol] (·) being the dynamic network.

16. The computer storage medium of claim 15, wherein the physical information neural network model is as follows:
$$ℋ := \frac{\partial ℱ ( t , x ; Φ )}{\partial t} - 𝒢 ( t , x , u , {u}_{t} , {u}_{x} ; Θ )$$
wherein Φ and θ respectively denote learnable parameters of the neural network,
$${u}_{t} = \frac{\partial u}{\partial t}$$
denotes a partial derivative of u with respect to the time t, and
$${u}_{x} = {[ \frac{\partial u}{\partial {x}_{1}} , \frac{\partial u}{\partial {x}_{2}} , … ]}^{⊤}$$
denotes a partial derivative of u with respect to the feature vector wherein both partial derivatives are computed by using an automatic differentiation mechanism of deep learning.

17. The electronic device of claim 10, wherein Step S200 comprises:
S201: constructing a partial differential equation satisfying a degradation trajectory of the industrial complex system based on the empirical degradation model of the industrial complex system; and
S202: constructing the physical information neural network model based on the partial differential equation.

18. The electronic device of claim 17, wherein in Step S201, the empirical degradation model of the industrial complex system is expressed as:
$$u = f ( t , x ) ,$$
wherein u denotes the degradation trajectory of the industrial complex system, and is described by a non-linear function ƒ(·), t denotes the time, and x denotes a feature vector.

19. The electronic device of claim 18, wherein an aging rate of the industrial complex system is expressed in the form of a partial differential equation:
$$\frac{\partial f ( t , x )}{\partial t} = g ( t , x , u ; θ ) ,$$
wherein θ denotes a parameter of the partial differential equation, g(·) denotes a non-linear function of the time t, the feature vector x and the degradation trajectory u itself, and g(·) is an internal dynamic function of degradation of the industrial complex system,
wherein the degeneration trajectory ƒ(·) is fitted by using a neural network [symbol] (·), the neural network [symbol] (·) being the solution network.

20. The electronic device of claim 18, wherein the internal dynamic function g(·) of degradation of the industrial complex system is captured by using a neural network [symbol] (·), the neural network [symbol] (·) being the dynamic network.
